(19) United States
(12) Patent Application Publication
(10) Pub. No.: US 2007/0046779 A1
(43) Pub. Date: Mar. 1, 2007

(54) An installation for recording travel and/or traffic

(76) Inventor: David Sourlier, Hemberg (DE)

Correspondence Address: LAW OFFICES OF MICHAEL M. AHMADSHAHI, 575 ANTON BLVD,. STE 300, COSTA MESA, CA, 92626, US

(21) Appl. No.: 10/578,698

(22) PCT Filed: Nov. 8, 2004
(86) PCT No.: PCT/CH04/00676

§ 371 Date: May 9, 2006

(30) Foreign Application Priority Data
Nov. 11, 2003 (CH) 1936/03

(51) Int. Cl. H04N 7/18

(52) U.S. Cl. 348/148; 348/159

(57) ABSTRACT

The traffic situation may be recorded by way of at least two detection cameras (2, 3) which are to be arranged at a distance (15) to one another on a vehicle (1). Their detection regions (11, 12) overlap (13), by which means at least one reference point (R) of the surroundings and/or recognition point of at least one second vehicle may be triangulated (T), e.g. by way of photogrammetry. After an accident, the behaviour of one or more vehicles (1) may be reconstructed. By way of the three-dimensional, temporally cycled detection, apart from the respective spatial position, the speed, the speed direction, direction changes, acceleration- and braking manoeuvres as well as intrinsic rotations of the individual vehicles about their centres of gravity may be visible and measured in a scaled manner. And this is all possible without having a multitude of sensors on the vehicles. The vehicles (1) may also be projected into a 3D picture of the surroundings, and thus a virtual representation from any viewers perspective may be computed and displayed.

The present invention relates to an installation for recording travel and/or traffic situations of vehicles. Furthermore, it relates to a method for evaluating these recordings.

Different installations for recording travel situations of vehicles are known. For example, the speed or the actuation of the brake is detected by sensors and registered in a short-term memory In this manner, at a later stage, one may call up the data in the short period of time before an accident and possibly reconstruct the course of events of the accident. Supplementary to the known sensors, it is likewise known to record in pictures and sound. Apart from the microphone, for this, video cameras are installed on the vehicle which record the events in front of or also behind the vehicle. This entails the advantage that—additionally to the behaviour of ones own vehicle—one records the traffic situation. In particular, in the ideal case, the behaviour and the registration numbers of other vehicles may be recognised.

Despite the number of apparatus to be installed, in the case of conflict however, one may only inadequately reconstruct the course of events of the accident, since the obtained data does not reliably represent the exact course of events and their spatial and temporal allocation with regard to the then traffic situation.

On the basis of this recognition, it is the object of the invention to provide an installation which makes do with few installations on the vehicle, but despite this permits an exact spatial allocation or the events in a three-dimensional space before a traffic accident or during a critic traffic situation. Furthermore, a method for evaluating the recordings created with this installation is to be specified.

In particular, apart from the exact 3D-position of all participating vehicles, their speed and acceleration are recorded in magnitude and direction.

The installation according to the invention corresponds to the characterising features of patent claim 1. The method according to the invention is deduced from claim 11. Further advantageous formations of the inventive concept are evident from the dependent patent claims.

One embodiment example of the invention is hereinafter described in more detail by way of the drawing.

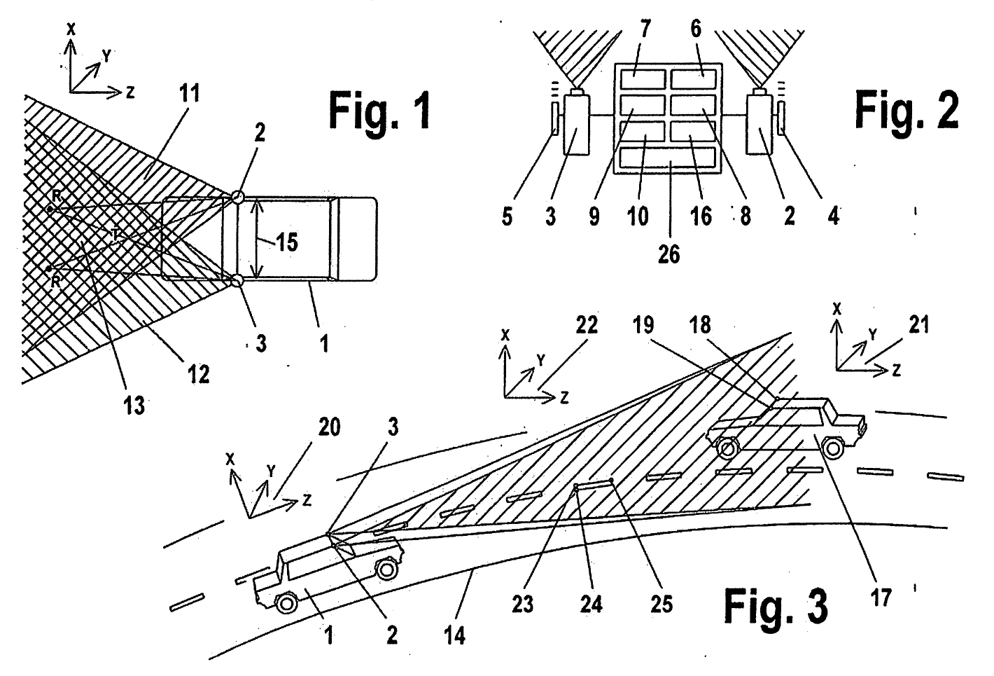

FIG. 1 shows a vehicle in a plan view;

FIG. 2 schematically shows the part of the installation which is to be attached on the vehicle and which serves for acquiring the data;

FIG. 3 shows the view of a traffic situation with two vehicles.

A vehicle 1 is equipped according to the FIGS. 1 and 2 with two schematically indicated detection cameras 2 and 3 serving for picture recording. Here it is preferably the case of digital cameras, to which in each case a microphone 4 and 5 is allocated. At least one memory is coupled to these detection cameras 2 and 3. In the present case, a non-volatile memory 6 or 7 is present in the manner of a circular buffer. Also each of the two detection cameras 2 and 3 may be provided with a separate memory 6 and 7. The purpose of the circular buffer will be dealt with at a later stage. Furthermore, at least one further, non-volatile memory 8 and 9 are provided, which is coupled to the memory serving as a circular buffer. This further memory may store the same quantity of data or pictures as the first one. The detection cameras 2 and 3 record pictures in rapid succession, for example 25× per second. They are mutually synchronised. Advantageously, a synchronisation at an exact time is effected. This may be effected by way of a radio clock 10. This means that the exact point in time of each picture is secured.

The two detection cameras 2 and 3 are aligned such that the region in front of the vehicle 1 is detected. Here, their detection ranges 11 and 12 overlap in an overlap region 13 which encompasses at least the road 14 in front of the vehicle 1, preferably however also in each case a lane to the left and right of this. The present schematic drawing only serves for explanation. With regard to the present invention, it neither fixes the position nor the alignment of the detection cameras 2 and 3. In the meanwhile, it is advantageous if the mutual distance 15 of the two detection cameras 2 and 3 is selected as large a possible.

The position and alignment of the two detection cameras 2 and 3 on the vehicle, in particular also their distance 15 to one another 15, is to be determined in each case and preferably likewise secured in a memory 16. The knowledge of the position of the detection cameras 2 and 3 to one another and their position on the vehicle itself, with methods of picture processing and photogrammetry, allows one to determine the exact position of one or more reference points. These methods are known per se. In the present case, reference points R which are visible on at least two pictures recorded synchronously by in each case one detection camera 2 and 3, may be exactly triangulated, as is indicated at T, so that their three-dimensional coordinates X, Y and Z may be exactly determined within a coordinate system.

It is to be added here, that within the framework of the invention, one may also provide more that two detection cameras 2 and 3. The measurement accuracy may be increased even further in particular by way of the use of a group of three detection cameras. Analogously to the detection cameras acting in the travel direction here, such cameras may also additionally be arranged at the rear. In theory even on both sides of the vehicle.

The practical implementation of the previously described knowledge in a traffic situation with two vehicles 1 and 17 approaching one another is evident from FIG. 3. The detection of the traffic situation by the detection cameras 2 and 3 of the first vehicle 1 is represented. If both vehicles 1 and 17 are equipped with these, this detection is effected additionally on the other vehicle and may be used for correction.

The recognition points 18 and 19 on the second vehicle 17 serving as reference points for the triangulation are preferably arranged specially for the purpose of automatic evaluation. It may be the case of white circles or points. They may also be designed in an illuminating manner, be it as passively illuminating elements, for example reflection marks or also as actively illuminating elements, for example light diodes. The elements may however illuminate in a manner which is invisible to the human eye, for example by way of infrared. The recognition points 18 and 19 should be arranged at an as large as possible distance to one another. It is also conceivable to attach these recognition points 18 and 19 on the corners of a standardised number plate or a number plate frame, possibly in a standardised position. The latter solutions would simplify the fitting and retrofitting of older vehicles.

It is expressly pointed out here that the application of the present installation is not limited to passenger cars. Any vehicle may be equipped with it, even two-wheeled vehicles. Finally, even the assembly on a bicycle is conceivable, since the costs and weight are relatively low. Furthermore, the installation may also be used without further ado on railed vehicles, from trams to trains. Water craft may just as easily provided with it, for example in river traffic. The application in aircraft is also conceivable. Thus for example in tight thermal regions, the risk of collision is also possible with regard to gliders.

Inasmuch as—as is the case with road vehicles—the surface in space on which the vehicle 1 and/or 17 has moved is known, two recognition points 18 and 19 are adequate for spatial reconstruction. In the case that this surface is not known or the vehicles has moved freely in space—for example in the case of an aircraft or water craft—then at least three recognition points 18 and 19 are necessary. With the movement not also a spatial line, for example with rail vehicles—one recognition point 18 or 19 is also sufficient.

The use of more than the minimal necessary number of recognition points increases the measurement accuracy. Thus also three recognition points may be provided with road vehicles. These are preferably arranged according to the Delauny criterion, i.e. as close as possible to a equilateral triangle, and at as large as possible distances. In each case, one recognition point may be attached to the headlights or the rear lights. A third recognition point may for example be arranged on the front side of the rear view mirror, or in the region of a third braking light which is often present in the rear window.

The various recognition points may also be coded, be it by way of different shape and/or colour. With actively illuminating recognition points, a coding may be effected by way of different flashing frequencies or -rhythms. This simplifies their automatic recognition and allocation by way of picture processing.

Of course it is however also possible to use elements which are present on the vehicle in any case as recognition points 18 and 19. These may be the headlights or the rear lights, the number plates or also elements of the vehicle design, such as edges and likewise.

If the position of the detection cameras 2 and 3 in the coordinate system 20 of the first vehicle 1 and the position of the recognition points 21 of the second vehicle 17 are known and stored, then—by way of suitable software—the position and movement of the two vehicles 1 and 17 before an accident may be computed and represented.

By way of the three-dimensional, temporally cycled detection, apart from the up-to-date spatial position, the momentary speed, the speed direction, direction changes, acceleration- and braking manoeuvres, as well as intrinsic rotations (spins) of the individual vehicles about their centres of gravity are visible and may be measured in a scaled manner. By way of this, one may particularly recognise how the vehicles were travelling before the accident, when a braking procedure was started, and how long it took before coming to a standstill. And this may all be accomplished without for this, having to have sensors on the steering wheels as well as the brake pedal and gas pedals. Apart from this, the knowledge of events with regard to the vehicle recorded in the picture, such as the lighting condition or indicator actuation and not least on the registration number and driver result due to the picture recording.

The parts of the installation serving for the data memory are to be secured against impacts and against undesired manipulation. A sealed, impact-proof, pressure-proof and fire-resistant container may serve for this. This container may also be provided with a locating possibility which simplifies its location after an accident. This may for example be a transmitter installation, a magnetically passive diode or a flashing device.

The evaluation of the data may be effected in an external manner after an accident or after a recorded critical traffic situation. The software required for this may be made available to a traffic expert. The evaluation may be effected automatically, semi-automatically or also manually. The described installation in any case also permits a time-saving automatic evaluation. The behaviour of a third vehicle recognisable from the recordings may be checked thereby.

With the evaluation, one may also take into account the mass and contours of the recorded, participating vehicle types. With this and by way of the previously described detection of the relative movement of the coordinate systems 20 and 21 of two or more vehicles 1 and 17 to one another, and of at least one coordinate system 20 of a vehicle 1 relative to the surroundings, it is possible to reconstruct the relative-position and movement of any selected points on the vehicles and/or the surroundings. The software may have a suitable data bank or call up the required data from such a data bank, for taking into account the participating vehicle types. If the vehicle type has not yet been recorded at this point in time, then this may be accomplished at a later stage without further ado. In order to include the surroundings of the accident location, the software should be designed such that the coordinate system 22 of the surroundings may also be included. The picture of the surroundings may either be taken from the present picture recordings, or at least one picture of the surroundings is recorded at a later stage. At least two pictures from different locations and viewing angles are required for the spatial reconstruction. Reference- or recognition points 23, 24 and 25 are also to be allocated to the stationary pictures of the surroundings. Thereby, it may for example be the case of recognition points 23, 24 and 25 on the central line of the road or on a guard railing or around the light points of a street post, which are present in any case. The mutual position of the vehicles 1 and 17 may be brought into relation with the stationary coordinate system 22 of the surroundings by way of this. The course of events of the accident or of the critical traffic situation may be projected into the picture of the surroundings and thus a reliable, virtual picture from the point of view of an external observer may be computed and represented, similar to the schematic representation according to FIG. 3. Thereby however it is not only the case of a static picture, but of a picture sequence, i.e. of a film of the events from a point in time before the accident up to the accident itself. The standing point of the observer may be infinitely changed, similarly to a hologram. The exact position and movement of each individual point may be called up according to requirement. In the case of conflict, this all considerably simplifies the explanation of the question of guilt.

It is clearly understood that a course of events of an accident may also be reconstructed from the recordings, when no second vehicle 17 takes part.

The behaviour of the one vehicle 1 may in any case be computed in relation to reference points R or recognition points 23, 24 and 25 of the surroundings

Information on the critical traffic situation, for example near accidents which have possibly have led to consequences for third parties, may be stored in the memories 8 and 9, whilst the constantly overwriting storage in the memories 6 and 7 designed as circular buffer is not stopped. The picture- and sound information may be evaluated when required, amongst other things for determining the registration numbers of the vehicles involved.

The previously mentioned intermediate storage may either be activated electronically or manually by the driver, for example by way of a button on the steering wheel. An electronic activation may be effected by the stoppage of the car 1, which may be detected by way of picture information which remains the same, or also by turning off the ignition or by way of not actuating the gas pedal for a few seconds. However, any other detectable signal may also be conceivable.

Calibrating means may also be present as accessories external to the vehicles, possibly also only as software for already existing installations. A first calibration may serve for the detection and computation of the position of the recognition points 18 and 19 as well as, as the case may be, further points in the coordinate system 21 of a vehicle 17. For this, mostly two stationary detection cameras are required. Furthermore, the position of detection cameras 2 and 3 assembled on a vehicle 1 may be computed in the coordinate system 20 of this vehicle 1 by way of a stationary set of photogrammetric recognition points.

The installation according to the invention for recording travel- and/or traffic situations of vehicles is relatively inexpensive. Digital cameras, as are used for example as web cams, may be obtained today at a low cost. This is also the case for microchips serving as a memory. The evaluation is indeed effected externally and creates no costs on the vehicles. Since, with regard to accidents, it is often the case of high material damage on the vehicles and possibly also expensive subsequent costs for injured persons, reliable proof is of an enormous advantage. It protects the traffic participant who behaves correctly from unjustified writs and compensation claims.

The installations may be designed in a manner differently to that previously described, within the framework of the invention. Amongst other things, a control controlling the sequences may be present.

1. An installation for recording travel- and/or traffic situations of vehicles, characterised by an arrangement to be attached to a vehicle (1), of at least two detection cameras (2, 3) lying at a distance (15) to one another, wherein their respective detection regions (11, 12) overlap or intersect in a common overlapping region (13), by which means at least one reference point (R) of the surroundings and/or recognition point (18, 19) at least of a second vehicle (17), recorded by two or more detection cameras (2, 3), may be triangulated 11), with the purpose, from a picture recording, of reconstructing its position and by way of this, the position and/or movement of at least one vehicle (1, 17) after an accident or after a critic traffic situation.

2. An installation according to claim 1, characterised in that the detection cameras (2, 3) are connected to at least one memory (6, 7, 8, 9), for storing recordings and/or data on their arrangement and/or on the vehicle (1).

3. An installation according to claim 1 or 2, characterised in that the distance (15) of the detection cameras (2, 3) amongst one another and/or their arrangement in a coordinate system (20) of a vehicle (1) is calibrated.

4. An installation according to claim 3, characterised in that the distance (15) of the detection cameras (2, 3) amongst one another and/or their arrangement in a coordinate system (20) of a vehicles (1) is secured in a memory

5. An installation according to one of the claims 1-4, characterised in that the detection cameras (2, 3) are connected to a time control (2, 3), in a manner such that their picture recording may be effected synchronised with respect to time.

6. An installation according to one of the claims 1-5, characterised in that the detection cameras (2, 3) are in each case designed for recording a picture sequence, for example 25 pictures per second.

7. An installation according to one of the claims 1-6, characterised in that the detection cameras (2, 3) are connected to a time measurement device, e.g. to a radio clock, with the purpose of being able to determine the absolute time of the respective picture recording.

8. An installation according to one of the claims 1-7, characterised in that at least one sound recording device, e.g. a microphone (4, 5) is present.

9. An installation according to one of the claims 2-8, characterised by a sensor, e.g. an acceleration sensor, for the automatic activation or for securing a data storage.

10. An installation according to one of the claims 2-9, characterised by an activation device, e.g. a button on the steering wheel, for the manual activation or for securing the data storage.

11. An installation according to one of the claims 2-10, characterised by at least one non-volatile memory (6, 7) in the manner of a circular buffer and by way of at least one further, non-volatile memory (8, 9) which is coupled to the memory (6,7) serving as a circular buffer.

12. An installation according to one of the claims 1-11, characterised by recognition points (18, 19, 23, 24, 25) detectable by detection cameras (2, 3), which are to be arranged on a vehicle (17) and/or in the region of traffic routes.

13. An installation according to claim 12, characterised in that the recognition points (18, 19, 23, 24, 25) are coded in shape and colour, e.g. in a manner such that each has its own shape in an arrangement of two or more recognition points (18, 19, 23, 24, 25).

14. An installation according to claim 12 or 13, characterised in that the recognition points (118, 19, 23, 24, 25) are designed illuminating in a passive manner, e.g. reflecting.

15. An installation according to claim 12 or 13, characterised in that the recognition points (18, 19, 23, 24, 25) are designed illuminating in an active manner, e.g. in the form of light diodes.

16. A method for evaluating recordings of travel and/or traffic situations created with the installation according to claim 1, characterised in that at least one reference point (R) and/or recognition point (18, 19, 23, 24, 25) recorded by two or more detection cameras (2, 3), is triangulated (I) with the purpose of reconstructing its position and by way of this, the position and/or movement of at least one vehicle (1, 17) after an accident or after a critic traffic situation.

17. A method according to claim 16, characterised in that the triangulation (R) is effected by picture processing and/or photogrammetry.

18. A method according to claim 16 or 17, characterised in that the computation of the position of the reference point or reference points (T) and/or recognition points (18, 19, 23, 24, 25) in the picture sequence of a picture recording is effected automatically in an apparatus programmable with suitable computation formulae, e.g. in a P.C.

19. A method according to claim 18, characterised in that the movements of at least one vehicle (1, 17) are computed from the position change of the reference point or reference points (T) or recognition points (18, 19, 23, 24, 25) in the picture sequence of a picture recording, e.g. the travel direction and any direction changes as well as speed and any speed changes, i.e. an acceleration or a braking procedure.

20. A method according to one of the claims 16-19, characterised in that in the computation of the position and/or movement of a vehicle (1, 17), the position of the detection cameras (2, 3) on a coordinate system (20) of this vehicle (1), and/or the position of recognition points (18, 19) on a coordinate system (21) at least of a second vehicle (17) are taken into account, wherein this data may be stored in a memory of the part of the installation arranged in the vehicle.

21. A method according to one of the claims 16-20, characterised in that a coordinate system (22) of the surroundings (22) flows into the computation of the position and/or movement of a vehicle (1, 17), wherein the picture of the surroundings may either be taken from the present picture recordings of the detection cameras (2, 3), or the surroundings may be recorded at a later stage.

22. A method according to claim 21, characterised in that reference points (R) or recognition points (23, 24) are allocated to the pictures of the surroundings, wherein it may be the case of points which are present in the surroundings in any case, e.g. on the central line of a road, on a crash barrier, or of reflecting points on a street post.

23. A method according to one of the claims 16 to 22, characterised in that the respective vehicle type is taken into account in the computation of the position and/or movement of a vehicle (1, 17), for which the data of this vehicle type e.g. may be inputted in a manual manner, or one may fall back on a data bank containing the data of a multitude of vehicle types.

24. A method according to one of the claims 21-23, characterised in that the position and the movement of one or more vehicles (1, 17) is projected into the picture of the surroundings and thus a virtual representation of the course of events of an accident or a critical traffic situation is computed and represented.
